(19) United States
(12) Patent Application Publication
(10) Pub. No.: US 2008/0036694 A1
(43) Pub. Date: Feb. 14, 2008

(54) Architecture for displaying data on a remote display

(75) Inventor: Hsienchih Bruce Yang, Taipei City (TW)

Correspondence Address: BIRCH STEWART KOLASCH & BIRCH, PO BOX 747, FALLS CHURCH, VA, 22040-0747, US

(73) Assignee: Hsienchih Bruce YANG

(21) Appl. No.: 11/730,108

(22) Filed: Mar. 29, 2007

(30) Foreign Application Priority Data
Aug. 9, 2006 (TW) 095129147

(51) Int. Cl. G09G 5/00

(52) U.S. Cl. 345/2.1

(57) ABSTRACT

The present invention relates to an architecture for displaying data on a remote display for use with an electric device, including a network system, a first device, a second device, a first display, a second display and a first input unit. When the first device and the second device respectively perform a target procedure, a user inputs a first specific data into the first device via the first input unit. The first device then transmits the first specific data to the second device via a first communication protocol and the network system. The second display subsequently displays a second specific data via the target procedure and the first specific data.

### BACKGROUND OF THE INVENTION

(a) Field of the Invention

The present invention relates to an architecture for displaying data on a remote display, particularly to an architecture for displaying data on a remote display, using real-time communication software.

(b) Description of the Prior Art

Nowadays, real-time communication is a type of widely used Internet services. Examples of common, real-time communication programs are the Yahoo Messenger of YAHOO Inc, Google Talk of GOOGLE Inc., MSN Messenger of Microsoft Corp. and Skype of SKYPE LIMITED. Real-time communication programs allow users to engage in real-time talk, data transmission and other Internet services with friends, family members and colleagues. Given these services are “real-time”, no E-mail replies are required, such that users can contact them, even if the other party is staying overseas. As real-time communication programs are communication tools that take privacy and personalization into account, users are required to add their friends, family members and colleagues into the contacts. Considering the cheap and convenient communication services provided by real-time communication programs, there is a dramatic growth in the number of users of real-time communication programs.

Nevertheless, existing real-time communication programs primarily provide communication functions using personal computers as the platforms. In response to a dramatic growth of real-time communication program users, this is a loss to the users if the applications of these real-time communication programs cannot be extended. As a result, the applications of real-time communication programs should be enhanced to create more business opportunities for the advancement of the industry and a higher quality of life for the users.

Currently, numerous electronic products display texts and graphics using creative means, for example, LED message clocks and projection clocks. Using a LED and the principle of the persistence of vision, LED message clocks display texts. The structure of a LED message clock includes at least a plurality of LEDs, a long rod and a motor. The plurality of LEDs is linearly arranged on a long rod, which is driven by the motor, such that the long rod moves and displays time in a fan-shaped area. In addition, projection clocks emit laser using laser LEDs and lenses and then display time on the projection face by scanning. FIG. 1 shows a schematic view of a conventional LED message clock and FIG. 2 shows a schematic view of a conventional projection clock.

Compared with traditional clocks, LED message clocks and projection clocks are more creative and interesting and provide a simple and interesting time display to the users. Unfortunately, LED message clocks and projection clocks are only employed to display time. Although some LED message clocks and projection clocks can display some texts, these texts are not variable and distinctive enough, given that they are pre-programmed in the LED message clocks. In this way, the applications of LED message clocks are restricted.

Conventional techniques provide a simple interface, such that users can transmit data to the LED message clocks through personal computers, in order to change the data so displayed. Nevertheless, this new data change model does not overcome the conventional drawback of inflexibility caused by text pre-programming. On the other hand, projection clocks currently lack transmission interfaces, making it impossible for projection clocks to connect to personal computers.

### SUMMARY OF THE INVENTION

The primary object of the present invention is to provide an architecture for displaying data on a remote display, using real-time communication programs and a network system, such that the architecture can display texts or graphics on a remote display.

To achieve the above object, the present application provides an architecture for displaying data on a remote display for use with an electronic device, including a network system, a first device, a second device, a first display, a second display and a first input unit. The first device and the second device are respectively coupled to the network system, while the first display is coupled to the first device while the second display is coupled to the second device. The first input unit is coupled to the first device. When the first device and the second device respectively perform a target procedure, a user inputs a first specific data into the first device via the first input unit. The first device then transmits the first specific data to the second device via a first communication protocol and the network system. The second display displays a second specific data via the target procedure and the first specific data.

In summary, the present invention provides an architecture for displaying data on a remote display for use with an electronic device. The present invention can broaden the applications of real-time communication programs and relevant display devices by combining real-time communication programs, LED message clocks and projection clocks, such that texts and graphics can be displayed in a diverse, interesting manner.

To enable a further understanding of the objectives and the technological methods of the invention herein, the brief description of the drawings below is followed by the detailed description of the preferred embodiments.

### BRIEF DESCIPTION OF THE DRAWINGS

FIG. 1 is a schematic view showing a conventional LED message clock.

FIG. 2 is a schematic view showing a conventional projection clock.

FIG. 3 is a schematic view showing an architecture for displaying data on a remote display made according to a preferred embodiment of the present invention.

FIG. 4 is a function block diagram of first display according to a preferred embodiment of the present invention.

FIG. 5 is a flow chart showing the target procedure made according to a preferred embodiment of the present invention.

FIG. 6 is a detailed flow chart showing the target procedure made according to a preferred embodiment of the present invention.

FIG. 7 is an analytical flow chart according to a preferred embodiment of the present invention.

FIG. 8 is a flow chart showing a display procedure made according to a preferred embodiment of the present invention.

### DETAILED DESCRIPTION OF THE PREFERRED EMBODIMENTS

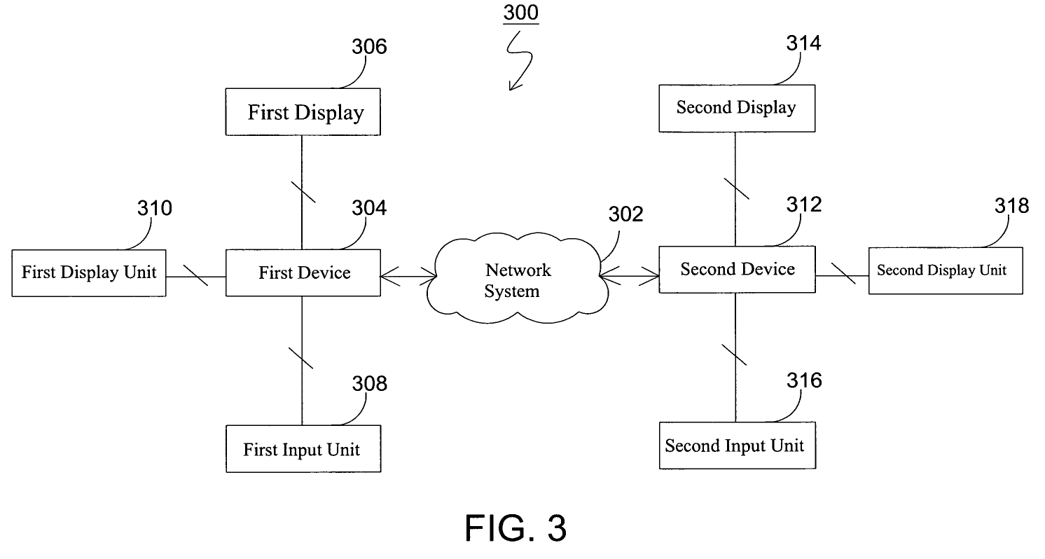

Referring to FIG. 3, the architecture for displaying data on a remote display disclosed in the present invention includes a network system 302, a first device 304, a first display 306, a first input unit 308, a first display unit 310, a second device 312, a second display 314, a second input unit 316 and a second display unit 318.

The first device 304 and the second device 312 are respectively coupled to the network system 302. The first display 306 is coupled to the first device 304. The second display 314 is coupled to the second device 312. The first input unit 308 is coupled to the first device 304. The second input unit 316 is coupled to the second device 312. The first device 304 is coupled to the first display unit 310. The second device 312 is coupled to the second display unit 318. According to the present embodiment, the first input unit 308 or the second input unit 316 is a keyboard, a handwriting input device or a voice input device. The first device 304 or the second device 312 is a personal computer, personal digital assistant (PDA) or mobile phone.

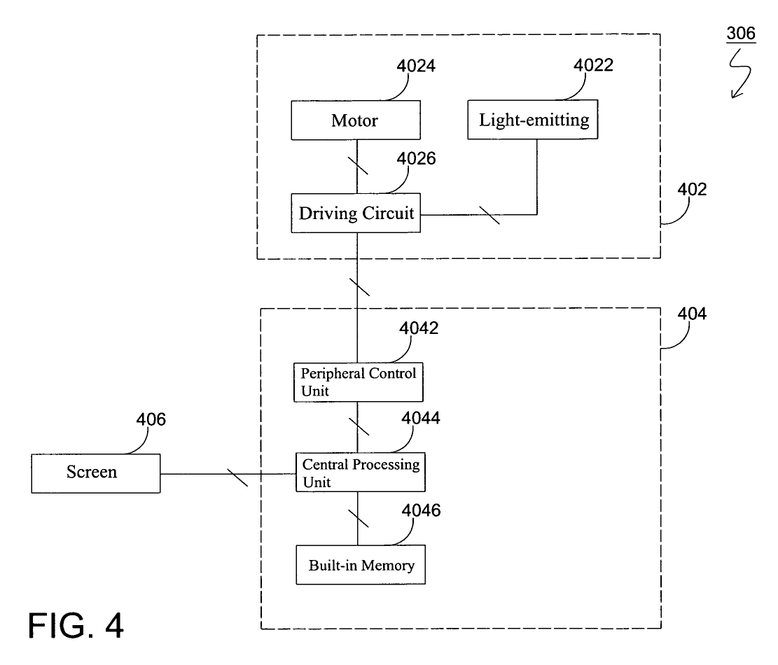

Referring to FIG. 4, the first display 306 includes a display module 402, a control unit 404 and a screen 406, wherein the display module 402 includes a Light-emitting 4022, a motor 4024 and a driving circuit 4026. The control unit 404 includes a peripheral control unit 4042, a central processing unit 4044 and a built-in memory 4046. The control unit 404 is coupled to the display module 402 and the screen 406. The central processing unit 4044 of the control unit 404 is coupled to the first device 304. The central processing unit 4044 is coupled to the peripheral control unit 4042 and the built-in memory 4046. The peripheral control unit 4042 includes a plurality of General Purpose I/Os (GPIO). The circuit block diagram of the second display 314 is similar to that of the first display 306.

When users of the first device 304 intend to display “I Love You” on a LED message clock on the remote end (that is, the second display 314) by using real-time communication programs, the first device 304 and the second device 312 respectively perform a target procedure. A user inputs a first specific data to the first device 304 via the first input unit 308. For example, the user inputs “:00_I Love You.” Then, via a first communication protocol and a network system 302, the first device 304 transmits the first specific data to the second device 312. Afterwards, via the target procedure and the first specific data, the second display 314 displays a second specific data. For example, the second display 314 displays “I Love You.” The real-time communication program is a Yahoo Messenger, Google Talk, MSN Messenger or Skype.

The control unit 404 causes data transmission between the first device 304 and the second device 312 via a second communication protocol. The second display 314 includes an actuating member (not shown in the drawing), which is connected to the motor 4024 and the Light-emitting 4022. The motor 4024 drives the actuating member, such that the Light-emitting 4022 can move so as to display the second specific data. The second communication protocol is a USB, a Bluetooth or a SATA.

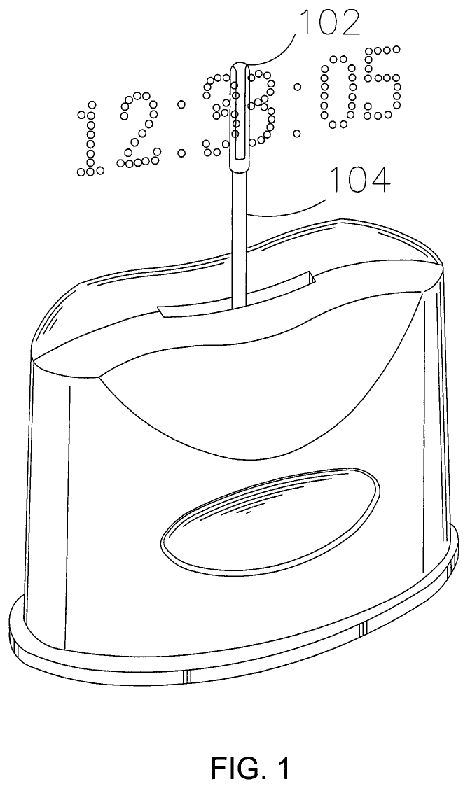

Referring to FIG. 1 and FIG. 4, if the second display 314 is a LED message clock, the Light-emitting 4022 includes a plurality of LEDs 102, which are disposed on a long bar 104. The plurality of LEDs 102 is linearly arranged and parallels to the central axis of the long bar 104. The long bar 104 is connected to the actuating member (not shown in the drawing), which actuates the long bar 104 to move leftward and rightward within a fixed region. When the long bar 104 moves leftward and rightward, corresponding specific LEDs at a specific location are turned on, data are displayed within the fixed region because of the visual persistence. In other words, the corresponding LEDs are turned on in each time interval to display the corresponding second specific data.

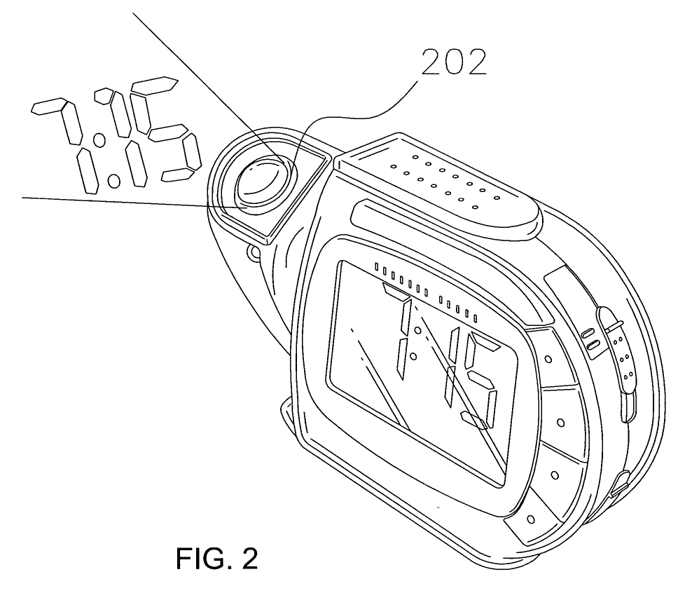

Referring to FIG. 2 and FIG. 4, the Light-emitting includes a laser Light-emitting (not shown in the drawing) and a lens 202. The laser Light-emitting emits laser by focusing via the lens 202. By moving the laser LED, laser can scan a fixed region, such that data are displayed within the fixed region.

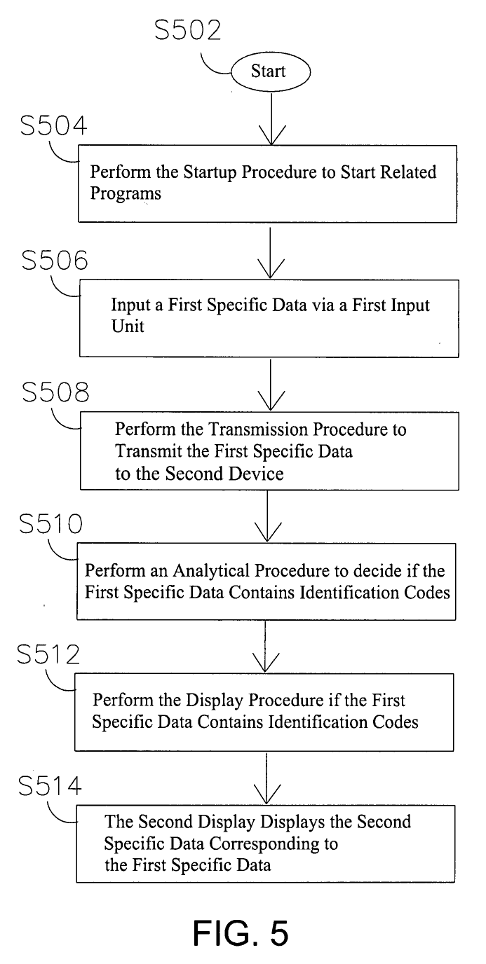

Referring to FIG. 5, the target procedure includes the steps: installing at least a related program on the first device and the second device after performing a startup program (S504); inputting a first specific data via the first input unit (S506); transmitting the first specific data to the second device via the network system and related programs when performing a transmission procedure (S508); deciding if the first specific data includes identification codes when the second device performs an analytical procedure (S510); the second device performs a display procedure if the first specific data includes identification codes (S512); and the second display displays the second specific data corresponding to the first specific data (S514).

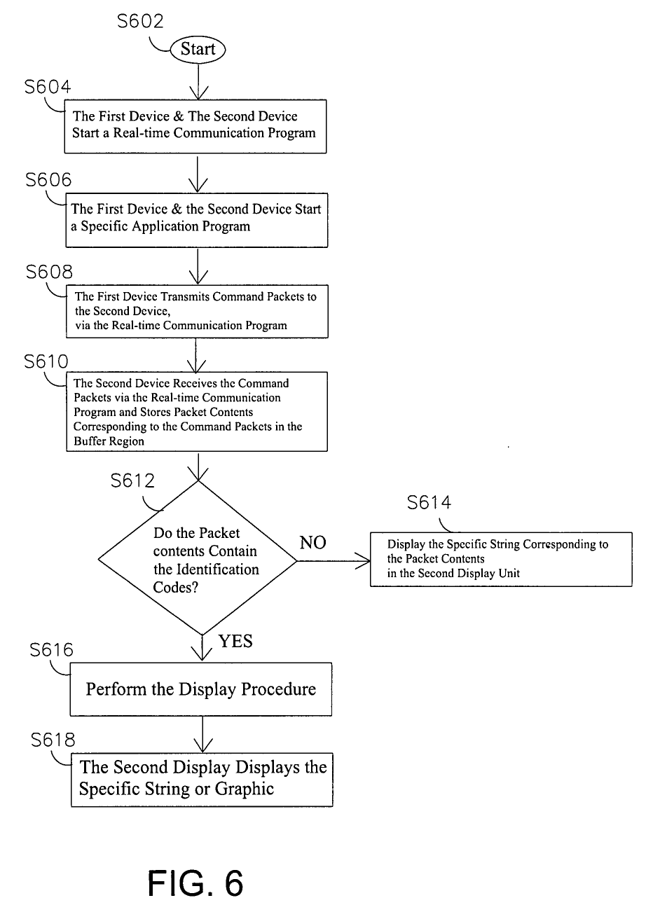

Referring to FIG. 6 & FIG. 5, the startup procedure includes the steps: the first device and the second device perform a real-time communication program (S604); and the first device and the second device perform a specific application program (S606). The transmission procedure includes the steps: the first device transmits command packets to the second device via the real-time communication program (S608); the second device receives the command packets via the real-time communication program and stores the packet contents corresponding command packets in the buffer (S610); deciding if the packet contents include the identification codes (S612); displaying the specific strings corresponding to the packet contents in the second display unit if the packet contents do not contain the identification codes (S614); performing a display procedure if the packet contents contain the identification codes (S616), and the second display displays the specific strings or graphics (S618).

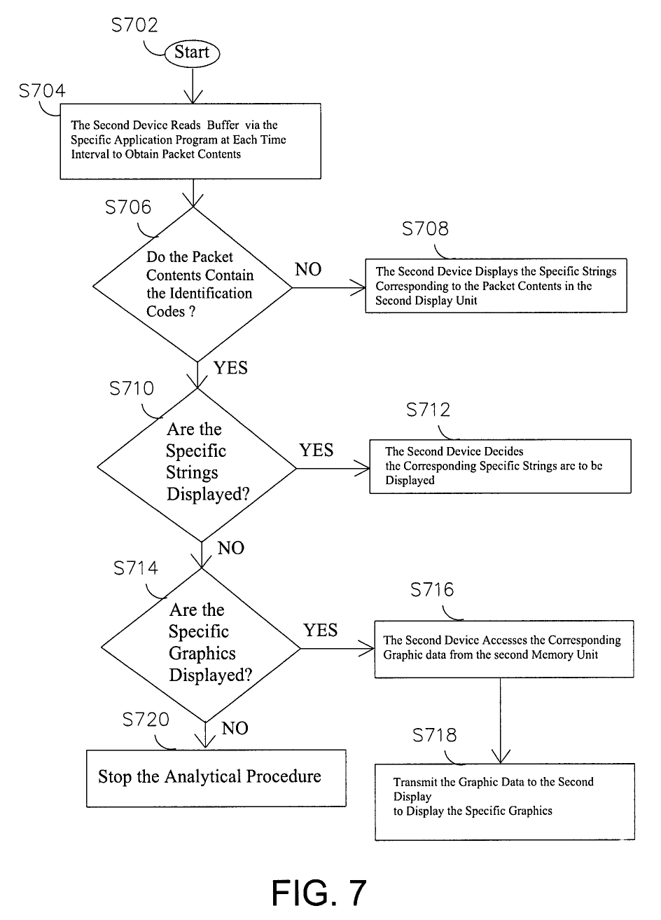

Referring to FIG. 7, the analytical procedure includes the steps: the second device reads the contents in the buffer via the specific application program at each time interval(polling) to obtain packet contents (S704); the second device analyzes the packet contents and decides if the packet contents contain the identification codes (S706); the second device displays the specific strings corresponding to the packet contents in the second display unit if the packet contents do not contain the identification codes (S708); the second device decides whether specific strings are to be displayed if the packet contents contain the identification codes (S710); the second display displays the specific strings corresponding to the packet contents if the second device decides that the specific strings are to be displayed (S712); the second device decides whether the specific graphics are to be displayed if the second device decides that the specific strings are not displayed (S714); the second device accesses the corresponding graphic data from the memory unit if the second device decides that the specific graphics are to be displayed (S716); displaying the specific graphics on the second display if the second device transmits graphic data to the second display (S718); and stopping the analytical procedure if the second device decides that the specific graphics are not to be displayed (S720). The specific strings are included in the packet contents and the graphic data are pre-stored in the second memory unit of the second device.

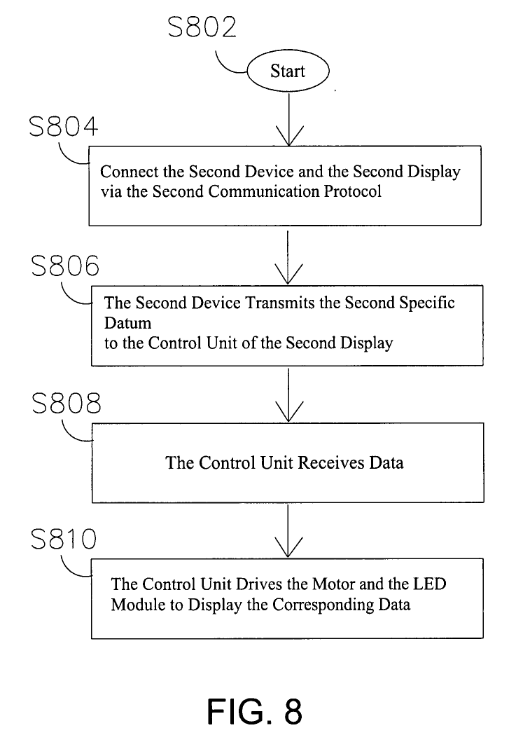

Referring to FIG. 8, the display procedure includes the steps: connecting the second device and the second display via the second communication protocol (S804); the second device transmits the second specific data to the control unit of the second display (S806); the control unit of the second display receives the second specific data (S808); and the control unit drives the motor and the Light-emitting to display the specific strings or graphics (S810).

It should be noted that the display method of the first display and the second display are mentioned herein for illustration. For example, the first display or the second display includes the control unit and the screen. The control unit is coupled to the corresponding first device or second device while the screen is coupled to the control unit. As soon as the control unit has received the second specific data, the second specific data is displayed on the screen. Currently, related devices such as digital photo frames, mobile phones and personal digital assistants can apply the structure of the present application.

What is claimed is:

1. An architecture for displaying data on a remote display for use with an electronic device, comprising:
a network system;
a first device, coupled to said network system;
a second device, coupled to said network system;
a second display, coupled to said second device; and
a first input unit, coupled to said first device;
when a target procedure is performed, inputting a first specific data to said first device via said first input unit, transmitting said first specific data to said second device via a first communication protocol, and displaying a second specific data by said second display via said target procedure and said first specific data.

2. The architecture for displaying data on a remote display as claimed in claim 1 wherein a second input unit is coupled to said second device.

3. The architecture for displaying data on a remote display as claimed in claim 1 wherein said first device is coupled to a first display unit.

4. The architecture for displaying data on a remote display as claimed in claim 1 wherein said second device is coupled to a second display unit.

5. The architecture for displaying data on a remote display as claimed in claim 1 wherein said first display is coupled to said first device.

6. The architecture for displaying data on a remote display as claimed in claim 5 wherein said first input unit or said second input unit is a keyboard, a handwriting input device or a voice input device.

7. The architecture for displaying data on a remote display as claimed in claim 1 wherein said first device or said second device is a personal computer, a personal digital assistant or a mobile phone.

8. The architecture for displaying data on a remote display as claimed in claim 1 wherein said first display or said second display comprises:
a control unit, coupled to said corresponding first device or second device for data transmission with said corresponding first device or second device via a second communication protocol;
a driving circuit, coupled to said control unit;
a light-emitting module, coupled to said driving circuit;
a motor, coupled to said driving circuit; and
an actuating member, connecting to said motor and said light-emitting module;
wherein said light-emitting module can move via said motor and said actuating member to display said second specific data.

9. The architecture for displaying data on a remote display as claimed in claim 8 wherein said control unit comprises:
a central processing unit;
an built-in memory, coupled to said central processing unit; and
a peripheral control unit, having at least a plurality of General Purpose I/Os (GPIO) and being coupled to said central processing unit.

10. The architecture for displaying data on a remote display as claimed in claim 8 wherein said second communication protocol is a USB, a Bluetooth protocol or a SATA.

11. The architecture for displaying data on a remote display as claimed in claim 8 wherein said Light-emitting comprises a plurality of LEDs.

12. The architecture for displaying data on a remote display as claimed in claim 11 wherein said LEDs of said Light-emitting are disposed on a long bar, and said LEDs are linearly arranged in parallel to the central axis of said long bar.

13. The architecture for displaying data on a remote display as claimed in claim 12 wherein said long bar is connected to said actuating member, which moves said long bar.

14. The architecture for displaying data on a remote display as claimed in claim 8 wherein said light-emitting module comprises at least:
a laser Light-emitting; and
a lens;
wherein said laser Light-emitting emits laser by focusing via said lens.

15. The architecture for displaying data on a remote display as claimed in claim 1 wherein said first display or said second display comprises:
a control unit, coupled to said corresponding first device or second device; and
a screen, coupled to said control unit;
wherein, said second specific data is displayed on said screen, when said control unit has received said second specific data.

16. The architecture for displaying data on a remote display as claimed in claim 1 wherein said target procedure comprises the steps:
performing a startup procedure, such that said first device and said second device start at least a related program;
performing a transmission procedure, such that said first specific data is transmitted to said second device via said network system and said related program;
performing an analytical procedure to decide if said first specific data contains at least one identification code; and
performing a display procedure if said first specific data contains said identification code, such that said second display displays said second specific data corresponding to said first specific data.

17. The architecture for displaying data on a remote display as claimed in claim 16 wherein said startup procedure comprises the steps:
starting a real-time communication program via said first device and said second device; and
starting a specific application program via said first device and said second device.

18. The architecture for displaying data on a remote display as claimed in claim 17 wherein said real-time communication program is a Yahoo Messenger, Google Talk, MSN Messenger or Skype.

19. The architecture for displaying data on a remote display as claimed in claim 16 wherein said transmission procedure comprises the steps:
transmitting a command packet by said first device to said second device via a real-time communication program;
receiving said command packet by said second device via said real-time communication program and storing a packet content corresponding to said command packet in a buffer.

20. The architecture for displaying data on a remote display as claimed in claim 16 wherein said analytical procedure comprises the steps:
reading said buffer to obtain a packet content at each time interval via a specific application program;
analyzing if said packet content contains a identification code;
displaying a specific string or a specific graphic if said packet content contains said identification code;
transmitting said specific string corresponding to said packet content to said second display if said identification code decides that said specific string is to be displayed, such that said second display displays said specific string;
accessing a corresponding graphic data from a second memory unit of said second device, if said identification code decides that said specific graphic is to be displayed; and
transmitting said graphic data to said second display, such that said second display displays said specific graphic.

21. The architecture for displaying data on a remote display as claimed in claim 20 wherein said specific string is comprised in said packet content.

22. The architecture for displaying data on a remote display as claimed in claim 20 wherein said graphic data is pre-stored in said second memory unit of said second device.

23. The architecture for displaying data on a remote display as claimed in claim 20 wherein said second display displays said specific string corresponding to said packet content, if said packet content does not contain said identification code.

24. The architecture for displaying data on a remote display as claimed in claim 16 wherein said display procedure comprises:
connecting said second device and said second display via a second communication protocol;
transmitting said second specific data to said second display by said second device; and
displaying a specific string or graphic, as soon as said second display has received said second specific data.

25. An architecture for displaying data on a remote display for use with an electronic device, comprising:
a network system;
a first device, coupled to said network system;
a second device, coupled to said network system;
a first input unit, coupled to said first device;
a first display, coupled to said first device; and
a second display, coupled to said second device, comprising:
a control unit, coupled to said second device for data transmission with said first device via a second communication protocol;
a driving circuit, coupled to said control unit;
a plurality of LEDs, coupled to said driving circuit and linearly arranged on a long bar, which is connected to an actuating member, such that said long bar moves via said motor and said actuating member, and said corresponding LEDs are turned on at each time interval to display a second specific data;
a motor, coupled to said driving circuit; and
an actuating member, connected to said motor and said Light-emitting;
inputting a first specific data to said first device via said first input unit after performing a target procedure, transmitting said first specific data to said second device via a first communication protocol and said network system, and displaying a second specific data by said second display via said target procedure and said first specific data.

26. The architecture for displaying data on a remote display as claimed in claim 25 wherein said target procedure comprises the steps:
performing a startup procedure such that said first device and said second device start at least a related program;
performing a transmission procedure to transmit said first specific data to said second device via said network system and said related program;
performing an analytical program to decide if said first specific data contains a identification code; and
performing a display procedure if said first specific data contains said identification code, such that said second display displays said second specific data corresponding to said first specific data.

27. The architecture for displaying data on a remote display as claimed in claim 26 wherein said transmission procedure comprises the steps:
transmitting a command packet to said second device by said first device via a real-time communication program; and
receiving said command packet by said second device via said real-time communication program and storing a packet content corresponding to said command packet in a buffer.

28. The architecture for displaying data on a remote display as claimed in claim 26 wherein said analytical procedure comprises the steps:
reading a buffer at each time interval via a specific application program to obtain a packet content;
analyzing if said packet content contains a identification code;
displaying a specific string or graphic if said packet content contains said identification code;
transmitting said corresponding specific string of said packet content to said second display, such that said second display displays said specific string, if said identification code decides that said specific string is to be displayed;
accessing a corresponding graphic data in a memory unit of said second device, if said identification code decides that said specific graphic is to be displayed; and
transmitting said graphic data to said second display, such that said second display displays said specific graphic.

29. The architecture for displaying data on a remote display as claimed in claim 26 wherein said display procedure comprises:
connecting said second device and said second display via a second communication protocol;
transmitting said second specific data to said second display by said second display; and
displaying a specific string or graphic, after said second display has received said second graphic data.
